(19) United States
(12) Patent Application Publication
(10) Pub. No.: US 2003/0032767 A1
(43) Pub. Date: Feb. 13, 2003

(54) High-strength polyester-amide fiber and process for producing the same

(76) Inventors: Yasuhiro Tada, Ibaraki (JP); Masayuki Hino, Ibaraki (JP); Toshiya Mizuno, Ibaraki (JP)

Correspondence Address: DINSMORE & SHOHL, LLP, 1900 CHEMED CENTER, 255 EAST FIFTH STREET, CINCINNATI, OH, 45202, US

(21) Appl. No.: 10/203,140

(22) PCT Filed: Feb. 5, 2001
(86) PCT No.: PCT/JP01/00792

(51) Int. Cl. C08G 69/08; C08G 73/10

(52) U.S. Cl. 528/310; 528/332

(57) ABSTRACT

A high-strength polyesteramide fiber comprising a polyesteramide copolymer is characterized by having a primary peak temperature that is at least 10° C. higher than that of a non-oriented material comprising the polyesteramide copolymer, as measured by dynamic viscoelastometry. A high-strength polyesteramide fiber production process is characterized by comprising a series of steps of melt spinning the polyesteramide copolymer, immediately followed by solidification by cooling in an inert cooling medium having a temperature of 20° C. or lower, thereby obtaining an undrawn filament; enhancing the crystallinity of the undrawn filament to 10 to 30% by weight; and subjecting the undrawn filament having a crystallinity of 10 to 30% by weight to a single- or multi-stage drawing in such a way as to give a total draw ratio of 4.5 times or greater.

### TECHNICAL FIELD

The present invention relates generally to high-strength polyesteramide fibers, and more specifically to high-strength polyesteramide fibers that have high linear tensile strength, reasonable elongation and biodegradability, and their production process. The high-strength polyesteramide fibers of the present invention are suitable for industrial materials such as fishing lines, fishing nets, and agricultural nets.

### BACKGROUND ART

In recent years, there have been growing demands for the development of earth-friendly fibers such as those having degradability like biodegradability and photo-degradability. In general, fishing lines, fishing nets, agricultural nets or the like are formed of synthetic fibers such as polyamide monofilaments excelling in processability, strength, durability, heat resistance, etc. For lack of degradability in natural environments, such conventional synthetic fibers cause pollution problems such as grave marine pollutions, for instance, when fishing lines or fishing nets are carried away for some reasons or left standing.

Although natural fibers, for the most part, are of biodegradability, yet they cannot give any high performance such as high strength demanded for industrial materials, e.g., fishing lines, fishing nets, and agricultural nets. Natural fibers also lack the processability needed for mass production. On the other hand, some aliphatic polyesters, known to degrade microbiologically by cohesive bacteria spread in the seas and rivers, can be processed into fibers making use of spinning technologies and facilities developed for conventional synthetic resins and so their applications to biodegradable fibers are now under consideration.

For instance, Japanese Patent Application Laid-Open No.(A) 02-203729 comes up with fishing lines formed of an aliphatic polyester having the nature of degrading gradually in natural environments. However, the publication does not say anything specific about spinning techniques, nor is there any example. To add to this, the publication states that fishing lines formed of aliphatic polyesters are sometimes hydrolyzed by atmospheric moisture, and that they should be thrown away because their strength decreases gradually after use.

JP-A 05-59611 comes up with monofilaments formed of polycaprolactone. According one specific example of that publication, polycaprolactone (having a melting point of 60° C.) is melt spun at 210° C., and cooled in an aqueous solution of 15° C. Immediately thereafter, the filament is subjected to the first-stage drawing in warm water of 45° C. at a draw ratio from higher than 5 times to less than 7 times, and then the second-stage drawing in an oven of 100° C. in such a way as to give a total draw ratio of 8 times or higher. The resulting filament is further subjected to relaxing thermal treatment, thereby obtaining a high-strength polycaprolactone monofilament. However, the polycaprolactone monofilaments are found to have insufficient heat resistance and show considerable strength drops under high-temperature conditions.

Thus, the fibers formed of aliphatic polyesters, albeit having biodegradability, have demerits such as insufficient mechanical strength and poor heat resistance. On the other hand, polyamide fibers excel in mechanical strength, heat resistance, processability, etc., but they have no biodegradability. For this reason, polyesteramide copolymers have been developed to improve the physical properties of aliphatic polyesters and impart biodegradability to polyamides, and their applications to biodegradable fibers are now under consideration.

For instance, JP-A 54-120727 discloses that a high-molecular-weight aliphatic polyester and a high-molecular-weight aliphatic polyamide are heated to a temperature higher than their respective melting points in an inert gas and in the presence of a catalyst such as anhydrous zinc acetate for ester-amide interchange reactions, thereby preparing a polyesteramide copolymer wherein a number of low-molecular-weight polyester blocks are bonded alternately with a number of low-molecular-weight polyamide blocks, and the polyesteramide copolymer is then melt spun into biodegradable fibers. However, the publication fails to show any specific example where said polyesteramide copolymer is spun into fibers.

JP-A 07-173716 discloses a monofilament comprising a polylactone-amide copolymer composed of polyamide units and polylactone units and a process for producing the same. The publication describes a monofilament production process wherein a polylactone-amide copolymer is melt spun, then solidified by cooling in an inert liquid of up to 60° C. (preferably 26 to 60° C.), then subjected to the first-stage drawing at a draw ratio ranging from higher than 4 times to less than 7 times, and finally drawn at such a draw ratio as to give a total draw ratio of 7 times or higher. According to one specific example of that publication, the polylactoneamide copolymer is melt spun at 200° C., and then cooled in warm water of 35° C. Immediately thereafter, the product is subjected to the first-stage drawing in a hot water bath of 80° C. at a draw ratio of 4.5 times, and then subjected to relaxing heat treatment in a hot water bath of 90° C. Following this, the product is subjected to the second-stage drawing in a dry heat bath of 120° C. in such a fashion as to give a total draw ratio of 9.0 times or higher, and finally subjected to relaxing heat treatment in a dry heat bath of 100° C., thereby preparing high-strength monofilaments.

To produce fibers like monofilaments from polyamide such as nylon, by the way, the polyamide is melt spun and rapidly cooled into undrawn filaments, which are immediately drawn. This is because the crystallization of the undrawn filaments is so inhibited by rapid cooling that molecular chains are reasonably oriented upon drawing. As the molecular chains are stretched out by drawing, there is orientation crystallization which allows both a crystal portion and an amorphous portion to be so fixedly oriented that excellent mechanical strength is achievable.

However, when such a spinning and drawing process is applied to a polyesteramide copolymer, it is difficult to obtain fibers with well-improved mechanical strength. In other words, polyamide segments in the polyesteramide copolymer are designed in such a way that the chain length becomes short to keep the biodegradability of said copolymer intact. For this reason, the polyesteramide copolymer has so low crystallinity that it is less susceptible to orientation crystallization as compared with polyamide homopolymers, or has a slow rate of crystallization. Only by drawing of amorphous undrawn filaments obtained by rapid cooling, it is thus impossible to achieve sufficient fixation of orientation of the amorphous portion, resulting in no sufficient improvement in mechanical strength.

If a polyesteramide copolymer designed such that the chain length of polyamide segments becomes short is spun into amorphous undrawn filaments and the undrawn filaments are subsequently drawn under a relatively high-temperature condition such as 50° C. or higher, then biodegradability may possibly be reconciled with mechanical strength. However, it is difficult to carry out such drawing satisfactorily because breaks are likely to occur upon drawing.

With a process wherein a part of undrawn filament is crystallized by controlling solidifying-by-cooling conditions such as cooling temperature, it is still impossible to achieve any satisfactory crystallinity or it is still difficult to place the crystallinity under precise control. Even when, to make a sensible tradeoff between biodegradability and mechanical strength, the polyesteramide copolymer designed in such a way as to permit polyamide segments to have a short chain length is melt spun and then solidified by cooling, and crystallized in a cooling medium adjusted to a relatively high temperature, the spun filaments are elongated or stretched in a zigzag line or otherwise deformed by the resistance of the cooling medium or the resistance of rolls because they are nearly in a molten state. Alternatively, the melt spun filaments may be crystallized by keeping them in air for a constant time; however, this is impractical for monofilaments having a relatively large diameter because cooling efficiency is extremely worse. It is also impossible to obtain any uniform filament diameter because the filaments nearly in a molten state have been deformed in air.

Thus, the polyesteramide copolymer obtained by the copolymerization of an aliphatic polyester and polyamide are expected as a resin having both the biodegradability of the aliphatic polyester and the toughness of the polyamide; however, with conventional production processes it is still difficult to produce polyesteramide fibers having biodegradability and mechanical strength in a well-balanced state, and sufficiently high strength as well.

### DISCLOSURE OF THE INVENTION

A primary object of the present invention is to provide a high-strength polyesteramide fiber that has particularly high linear tensile strength and reasonable elongation and shows biodegradability as well, and a process for the production of the same.

As a result of intensive studies made so as to accomplish the aforesaid object, the inventors have now found that the linear tensile strength of polyesteramide fibers can be outstandingly improved by the regulation of their primary dispersion peak temperature in dynamic viscoelastometry. The high-strength polyesteramide fibers of the present invention may be produced by melt spinning a polyesteramide copolymer immediately followed by solidification by cooling in a cooling medium of 20° C. or lower, preferably 15° C. or lower, and more preferably 10° C. or lower, thereby obtaining a substantially amorphous undrawn filament, enhancing the crystallinity of the undrawn filament to 10 to 30% by weight, and subjecting the undrawn filament to a single- or multi-stage drawing in such a way as to give a total draw ratio of 4.5 times or greater, and preferably 5 times or greater. The crystallinity of the undrawn filament may be enhanced to 10 to 30% by weight as by, for example, letting the undrawn filament stand at room temperature for 24 hours, thereby proceeding its crystallization sufficiently.

At the drawing step, the undrawn filament having a crystallinity of 10 to 30% by weight is subjected to the single- or multi-stage drawing at a temperature of 20 to 120° C. in such a way as to give a total draw ratio of 4.5 times or greater. If, in this case, there is at least one drawing step where drawing is carried out at preferably 50 to 120° C., more preferably 70 to 110° C. and at a draw ratio of 1.3 times or greater, it is then possible to obtain much better results. Alternatively, it is possible to obtain the high-strength polyesteramide fibers of the present invention even with recourse to a process wherein a substantially amorphous undrawn filament is drawn into a drawn filament and the drawn filament is subjected to a single- or multi-stage drawing after its crystallinity is increased to 10 to 30% by weight. The present invention has been accomplished on the basis of these findings.

Thus, the present invention provides a high-strength polyesteramide fiber comprising a polyesteramide copolymer, which has a primary dispersion peak temperature as measured by dynamic viscoelastometry of at least 10° C. higher than a primary dispersion peak temperature of a non-oriented material comprising the polyesteramide copolymer.

The present invention also provides a polyesteramide fiber production process comprising melt spinning a polyesteramide copolymer and drawing the resultant undrawn filament, which comprises a series of steps of:

(1) melt spinning the polyesteramide copolymer, immediately followed by solidification by cooling in an inert cooling medium having a temperature of 20° C. or lower, thereby obtaining an undrawn filament,

(2) enhancing a crystallinity of the undrawn filament to 10 to 30% by weight, and

(3) subjecting the undrawn filament having a crystallinity of 10 to 30% by weight to a single- or multi-stage drawing in such a way as to give a total draw ratio of 4.5 times or greater.

Furthermore, the present invention provides a polyesteramide fiber production process comprising melt spinning a polyesteramide copolymer and drawing the resultant undrawn filament, which comprises a series of steps of:

(I) melt spinning the polyesteramide copolymer, immediately followed by solidification by cooling in an inert cooling medium having a temperature of 20° C. or lower, thereby obtaining an undrawn filament,

(II) drawing the undrawn filament at a temperature of −10° C. to 50° C. and at a draw ratio of 1.3 times or greater, thereby obtaining a drawn filament,

(III) enhancing a crystallinity of said drawn filament to 10 to 30% by weight, and

(IV) subjecting the drawn filament having a crystallinity of 10 to 30% by weight to a single- or multi-stage drawing in such a way as to give a total draw ratio of 4.5 times or greater.

### BEST MODE FOR CARRYING OUT THE INVENTION

1. Polyesteramide Copolymer

The polyesteramide copolymer used herein is a polymer having a polyamide unit and a polyester unit in its molecular chain. The polymer should comprise polyamide units at a proportion of preferably 5 to 80 mol %, more preferably 20 to 70 mol % and even more preferably 30 to 60 mol %, and polyester units at a proportion of preferably 20 to 95 mol %, more preferably 30 to 80 mol % and even more preferably 40 to 70 mol %, accordingly. Too little polyamide units give rise to mechanical strength drops, and too much is detrimental to biodegradability.

A variety of known polyamides may be used for the polyamide units. Polyamide 6 (nylon 6) and polyamide 66 (nylon 66) or their copolymers are preferred, because the use of polyamides having too high a melting point renders the thermal decomposition of polyester segments likely to occur upon melt spinning. In consideration of biodegradability, aliphatic polyesters are preferred for the polyester units. Insofar as biodegradability is ensured, alicyclic polyesters or aromatic polyesters, for instance, polycyclohexylenedimethyl adipate, may be used alone or in combination with the aliphatic polyesters. Polybutylene adipate, polyethylene adipate and polylactone are preferable for the aliphatic polyesters.

By way of example but not by way of limitation, the polyesteramide copolymer may be synthesized by (1) a process wherein a number of polyamide units are alternately introduced in the aliphatic polyester through amide-ester interchanges reactions to form a polyesteramide copolymer (JP-A 54-120727), (2) a process wherein a polyamide-forming compound (e.g., ε-caprolactam) reacts with a dicarboxylic acid and a polyester diol (e.g., polylactone diol) (JP-A 07-173716), and (3) a process wherein a polyamide-forming compound (e.g., ε-caprolactam) reacts with a polyester-forming compound (e.g., a dibasic acid and a diol; lactone).

The polyester used for the aforesaid process (1), for instance, includes polycaprolactone, polyethylene adipate and polybutylene adipate, and the polyamide includes nylon 6, nylon 66, nylon 69, nylon 610, nylon 612, nylon 11, nylon 12 and so on.

The polyamide-forming compound, for instance, includes aminocarboxylic acids having 4 to 12 carbon atoms such as ω-aminobutyric acid, ω-aminovalerianic acid, ω-aminocaproic acid, ω-aminoenanthic acid, ω-aminocaprylic acid, ω-aminopelargonic acid, ω-aminoundecanoic acid and ω-aminododecanoic acid, and lactams having 4 to 12 carbon atoms such as γ-butyrolactam, ε-caprolactam, enantholactam, caprylolactam and laurolactam. The polyamide-forming compound, for instance, includes nylon salts comprising dicarboxylic acids and diamines. The dicarboxylic acids, for instance, include aliphatic dicarboxylic acids having 4 to 12 carbon atoms such as succinic acid, glutaric acid, adipic acid, pimelic acid, suberic acid, sebacic acid, azelaic acid and dodecandioylic acid; alicyclic dicarboxylic acids such as hydrogenated terephthalic acid and hydrogenated isophthalic acid; and aromatic dicarboxylic acids such as terephthalic acid, isophthalic acid and phthalic acid. The diamines, for instance, include aliphatic diamines having 4 to 12 carbon atoms such as tetramethylenediamine, pentamethylenediamine, hexamethylenediamine, hepta-methylenediamine, octamethylenediamine, nonamethylenediamine, decamethylenediamine, undecamethylenediamine and dodecamethylenediamine; alicyclic diamines such as cyclohexanediamine and methylcyclohexanediamine; and aromatic diamines such as xylenediamine.

The dicarboxylic acid used for the aforesaid process (2), for instance, includes aliphatic dicarboxylic acids such as succinic acid, glutaric acid, adipic acid, pimelic acid, suberic acid, sebacic acid, azelaic acid and dodecandioylic acid; alicyclic dicarboxylic acids such as hydrogenated terephthalic acid and hydrogenated isophthalic acid; and aromatic dicarboxylic acids such as terephthalic acid, isophthalic acid and phthalic acid.

The polyester diol used for the aforesaid process (2), for instance, includes polylactone diols having an average molecular weight of 500 to 4,000, which are synthesized from lactones having 3 to 12 carbon atoms using a glycol compound as a reaction initiator. The lactones, for instance, include β-propiolactone, β-butyrolactone, δ-valerolactone, ε-caprolactone, enantholactone, caprylolactone and laurolactone.

The dibasic acid used for the aforesaid process (3), for instance, includes adipic acid, pimelic acid, suberic acid, sebacic acid, azelaic acid and dodecanedioic acid, and the diol, for instance, includes ethylene glycol, 1,3-propanediol, 1,4-butanediol, 1,5-pentanediol, 1,6-hexanediol, 2,3-butanediol, 2,5-hexanediol, 2-methyl-1,4-butanediol, 3-methyl-2,4-pentanediol, 2-methyl-2,4-pentanediol, 2-ethyl-2-methyl-1,3-propanediol and 2,3-dimethyl-2,3-butanediol.

The lactone used for the aforesaid process (3), for instance, includes β-propiolactone, β-butyrolactone, δ-valerolactone, ε-caprolactone, enantholactone, caprylolactone and laurolactone. Besides, glycolic acid, glycolide, lactic acid, β-hydroxybutyric acid, β-hydroxyvaleric acid, etc. may be used as the polyester-forming compounds.

In view of the balance between mechanical strength and biodegradability, preferable polyesteramide copolymers are nylon 6/polybutylene adipate copolymers, nylon 66/polybutylene adipate copolymers, nylon 6/polyethylene adipate copolymers, nylon 66/polyethylene adipate copolymers, nylon 6/polycaprolactone copolymers, nylon 66/polycaprolactone copolymers, etc.

The polyesteramide copolymer should have a melting point (Tm) of preferably 90° C. or higher, more preferably 100° C. or higher and often 90 to 180° C. The melting point (Tm) of polyesteramide copolymers is defined by a crystal melting peak temperature as measured at a heating rate of 10° C./min., using a differential scanning calorimeter. When there are a plurality of melting peaks, the melting point is defined by a peak having the largest heat value. A polyesteramide copolymer having too low a melting point results in polyesteramide fibers vulnerable to strength drops in hot environments or breaks due to frictional heat generated when they are used. When this melting point is too high, on the other hand, melt spinning must be carried out at elevated temperatures at which polyester segments tends to cause thermal decomposition.

The polyesteramide copolymers should have a relative viscosity of preferably 1.0 or greater, more preferably 1.3 or greater and often 1.0 to 3.0. The relative viscosity of the polyesteramide copolymer is determined by measuring the viscosity of a polymer solution at a concentration of 0.4 g/dl (at which 0.4 gram of polymer is dissolved in 100 ml of hexafluoroisopropanpl (HFIP) solvent), using an Ubbelohde viscometer in an atmosphere at a temperature of 10° C. With a polyesteramide copolymer having too low a relative viscosity, it is difficult to obtain fibers with improved mechanical strength, because the degree of polymerization (or the molecular weight) is too low. Too high a relative viscosity again makes it difficult to obtain fibers having uniform physical properties because the fibers are prone to diameter spots or strength spots.

2. Polyesteramide Fiber Production Process

According to the present invention, the polyesteramide copolymer is used to prepare polyesteramide fibers through the following steps. While polyesteramide fibers are usually in monofilament forms, it is understood that they may be provided in multifilament forms as desired.

Specifically in the polyesteramide fiber production process of the present invention, the polyesteramide copolymer is melt spun, and the resultant undrawn filament is drawn. The present production process is carried out such a series of steps as mentioned below.

At step (1), the polyesteramide copolymer is melt spun, immediately followed by solidification by cooling in an inert cooling medium at a temperature of 20° C. or lower, thereby obtaining an amorphous undrawn filament,

at step (2), the crystallinity of the undrawn filament is enhanced to 10 to 30% by weight, and

at step (3), the undrawn filament having a crystallinity of 10 to 30% by weight is subjected to the single- or multi-stage drawing in such a way as to give a total draw ratio of 4.5 times or greater.

At the aforesaid step (1), the polyesteramide copolymer is melt spun, immediately followed by solidification by cooling in an inert cooling medium at a temperature of 20° C. or lower, preferably 15° C. or lower, and more preferably 10° C. or lower, thereby obtaining a substantially amorphous undrawn filament. The melt spinning temperature is usually of the order of 100 to 200° C., and the spinning take-off speed is usually of the order of 1 to 50 m/min. for monofilaments, and of the order of 20 to 1,000 m/min. for multifilaments.

When the temperature of the cooling medium is too high, some portions of the undrawn filament may be crystallized. This in turn makes it difficult to place the crystallinity under uniform and precise control and, hence, renders it difficult to obtain polyesteramide fibers having sufficient mechanical strength. With a cooling medium having too high a temperature, it is also difficult to form uniform fibers because of deformation of the undrawn filament. The lower-limit temperature of the cooling medium should preferably be about 0° C., although depending on the type of the cooling medium. For the cooling medium, for instance, use may be made of liquid compounds inert with respect to the polyesteramide copolymer such as water, glycerin, and ethylene glycol, and their mixtures, among which water is preferred. At this step (1), substantially amorphous undrawn filaments are obtained, having a crystallinity of preferably 5% or lower, more preferably 3% or lower, and generally 0%.

At the aforesaid step (2), the crystallinity of the substantially amorphous undrawn filament is enhanced to the range of 10 to 30% by weight, and preferably 12 to 28% by weight. The crystallinity of the undrawn filament obtained at step (1), for instance, may be enhanced by placing the undrawn filament in an atmosphere of 10 to 80° C. for 10 minutes to 72 hours. In general, it is preferable to regulate the crystallinity within the desired range by extending the treatment time at a low atmosphere temperature, and shortening the treatment time at a high atmosphere temperature. For this crystallization treatment, it is preferable that while the substantially amorphous undrawn filament obtained at step (1) is wound on a roll or the like, it is let stand in an atmosphere held under a given temperature condition for a given time. To place the crystallinity of the undrawn filament under precise control, it is preferable to let the wound-up undrawn filament stand in an atmosphere regulated at a given temperature in the range of 10 to 35° C. for a given time of usually 5 to 72 hours, and preferably about 10 to 30 hours.

By doing so, the crystallinity of undrawn filaments formed of the polyesteramide copolymer that has generally low crystallizability and a slow rate of crystallization can be precisely controlled within the desired range. As the crystallinity of the undrawn filament becomes too low, it is impossible to provide any sufficient fixation of the orientation of an amorphous portion upon drawing and, hence, it is difficult to obtain fibers having improved strength. As the crystallinity of the undrawn filament becomes too high, on the other hand, the strength of the filament drops due to the occurrence of voids upon drawing. In some cases, the filament may break during drawing.

At the aforesaid step (3), the undrawn filament having a crystallinity of 10 to 30% by weight is subjected to the single- or multi-stage drawing in such a way as to give a total draw ratio of 4.5 times or greater. Hereinafter, this step may be called the crystalline drawing step. The drawing temperature should preferably be in the range of 20 to 120° C., and the upper limit thereto may be set at a temperature lower than the melting point (Tm) of the polyesteramide copolymer used. This drawing temperature setting is carried out with a dry heat gas or a liquid heat medium regulated to a given temperature.

According to the present invention, drawing is carried out at a single stage or two or more stages. To obtain fibers of high strength, it is then particularly desirable to set the drawing temperature at preferably 50 to 120° C. and more preferably 70 to 110° C. and provide a drawing stage for carrying out drawing at said temperature and at a draw ratio of 1.3 times or greater. Drawing at that temperature should preferably be carried out in a dry heat gas. By providing this drawing stage, the crystallinity of the drawn filament can be enhanced to a suitable range and, at the same time, the orientation (degree of crystal orientation) of crystalline segments and amorphous segments can be fully enhanced with the result that fibers excelling in mechanical strength can be obtained.

Drawing at this drawing stage, for instance, one single-stage drawing may be carried out at a drawing temperature of 70 to 110° C. and at a draw ratio of 5 to 7 times. For multi-stage drawing, if there is a drawing stage for carrying out drawing in the aforesaid temperature range at a draw ratio of 1.3 times or greater, drawing at other drawing stage may then be carried out at a temperature less than 50° C., for instance, 25° C. Drawing at this drawing stage may be carried out in a single- or multi-stage fashion and preferably at a draw ratio of 1.3 times to up to 12 times.

The total draw ratio should be 4.5 times or greater, and preferably 5 times or greater, and the upper limit thereto is placed at about 15 times. At too low a total draw ratio, no sufficient mechanical strength can be obtained. After the drawing step, the drawn filament may be thermally treated at a temperature of the melting point (Tm) or lower while it is in a constant-length or relaxing state.

According to the present invention, it is also possible to produce high-strength polyesteramide fibers with biodegradability well reconciled with mechanical strength through the following steps.

At step (I), the polyesteramide copolymer is melt spun, immediately followed by solidification by cooling in an inert cooling medium at a temperature of 20° C. or lower, thereby obtaining an amorphous undrawn filament,

at step (II), the undrawn filament is drawn at a temperature of −10° C. to 50° C. and at a draw ratio of 1.3 times or greater into a drawn filament,

at step (III), the crystallinity of the drawn filament is enhanced to 10 to 30% by weight, and

at step (IV), the drawn filament having a crystallinity of 10 to 30% by weight is subjected to the single- or multi-stage drawing in such a way as to give a total draw ratio of 4.5 times or greater.

At the aforesaid step (I), the polyesteramide copolymer is melt spun at a temperature of usually about 100 to 200° C. The spinning take-off speed is usually of the order of 1 to 50 m/min, and the temperature of the cooling medium is preferably 15° C. or lower, and more preferably 10° C. or lower. At the aforesaid step (II), the drawing temperature is preferably 0 to 40° C., and more preferably 10 to 35° C., and the draw ratio is preferably 2 times or greater, and more preferably 3 times or greater. In most cases, satisfactory outcomes are obtained in the draw ratio range of about 4 to 10 times. To enhance the draw ratio at this step (II), it is preferable to carry out multi-stage drawing involving about 2 to 5 drawing cycles at a drawing temperature of the order of 10 to 35° C.

The aforesaid step (II) is an amorphous drawing step for drawing the substantially amorphous undrawn filament. The crystallinity of the drawn filament obtained at step (II) is enhanced to the range of 10 to 30% by weight, and preferably 12 to 28% by weight. The crystallinity of the drawn filament, for instance, may be enhanced by placing the drawn filament in an atmosphere of 10 to 80° C. for 10 minutes to 72 hours. For this crystallization treatment, it is preferable that while the drawn filament obtained at step (II) is wound on a roll or the like, it is let stand in an atmosphere held under a given temperature condition for a given time. To place the crystallinity of the drawn filament under precise control, it is preferable to let the wound-up drawn filament stand in an atmosphere regulated at a given temperature in the range of 10 to 35° C. for a given time of usually 5 to 72 hours, and preferably about 10 to 30 hours.

With the process comprising the steps of drawing the undrawn filament in an amorphous state, enhancing the crystallinity to the range of 10 to 30% by weight and carrying out drawing (IV), it is possible to obtain sufficiently high mechanical strength. At step (IV), the drawn filament having a crystallinity of 10 to 30% by weight is subjected to the single- or multi-stage drawing in such a way as to give a total draw ratio of 4.5 times or greater. The drawing temperature is preferably 20 to 120° C., and may be controlled using a dry heat gas or liquid heat medium regulated to a given temperature. To obtain high-strength fibers at drawing step (IV), it is particularly preferable to provide a drawing stage where the drawing temperature is regulated to the range of preferably 50 to 120° C., and more preferably 70 to 110° C. and drawing is carried out at a draw ratio of 1.3 times or greater at that drawing temperature. Otherwise, the drawing conditions are the same as already mentioned.

3. Polyesteramide Fibers

The polyesteramide fiber of the present invention should have a primary dispersion peak temperature that is at least 10° C., preferably at least 12° C., higher than that of a non-oriented material comprising the aforesaid polyesteramide copolymer, as measured by dynamic viscoeleastometry. The drawn fiber having a primary dispersion peak temperature at least 10° C. higher than that of the non-oriented material implies that its amorphous molecular chain is highly constrained under tension. It follows that drawing has occurred effectively with the result that not only the molecular chain of a crystalline portion of the fiber but also the molecular chain of an amorphous portion thereof has been highly oriented. The upper limit to the primary dispersion peak temperature difference is about 17° C. and, in most cases, about 15° C.

For the polyesteramide fiber of the present invention, it is preferable that the relation between the crystallinity A (% by weight) of that fiber and the long period B (Å) of that fiber as measured by small angle X-ray scattering satisfies the following formula (I):

5≦(i ×B)/100≦30 (I).

The relation between the crystallinity A and the long period B as measured by small angle X-ray scattering should satisfy:

more preferably

10≦(A×B)/100≦25 (II),

and even more preferably

15≦(A×B)/100≦20 (III).

The product of the crystallinity A and the long period B as measured by small angle X-ray scattering should be equal to the thickness of a crystal formed by the crystallization of a polyamide segment. A fiber such as one where (A×B)/100<5 is poor in crystallinity due to a short chain length of polyamide segments, and so there is a fear that the polyamide unit introduced in the molecular chain makes no sufficient contribution to mechanical strength improvements. On the other hand, a fiber such as one where (A×B)/100>25 may be detrimental to biodegradability because of too long a chain length of polyamide segments.

The polyesteramide fiber of the present invention should have a degree of crystal orientation of preferably 90% or greater, and more preferably 93% or greater. The upper limit to the degree of crystal orientation is approximately 98%. A fiber having a high degree of crystal orientation means that its mechanical strength is improved.

Such polyesteramide fibers may be obtained by the aforesaid production process, with improved linear tensile strength combined with reasonable elongation.

Specifically, the polyesteramide fiber of the present invention may be obtained by enhancing the crystallinity of an amorphous undrawn filament comprising a polyesteramide copolymer to 10 to 30% by weight, and then drawing the same. The polyesteramide fiber of the present invention may also be obtained by drawing an amorphous undrawn filament comprising a polyesteramide copolymer, then enhancing the crystallinity of the thus obtained drawn filament to 10 to 30% by weight, and finally drawing the same.

The polyesteramide fiber of the present invention has a linear tensile strength of usually 300 MPa or greater, preferably 350 MPa or greater, more preferably 380 MPa or greater, and even more preferably 400 MPa or greater. In most cases, the linear tensile strength is of the order of 380 to 700 MPa. The polyesteramide fiber of the present invention has a elongation of usually 10% or greater, preferably 15% or greater and, in most cases, of the order of 10 to 50%.

The polyesteramide fiber of the present invention should preferably have satisfactory biodegradability. The polyesteramide fiber of the present invention can be evaluated as being of satisfactory microbiological biodegradability from the fact that when it was dug out of the ground where it was buried for 6 months, it lost shape or its linear tensile strength showed a 50% lower than its original value before burying. The polyesteramide fiber of the present invention has a diameter of usually about 50 to 4,000 μm for monofilament and usually 1 to 50 μm for multifilament. If required, the polyesteramide fiber of the present invention may contain various additives such as pigments, dyes, antioxidants, UV absorbers and plasticizers.

### EXAMPLES

The present invention is now explained more specifically with reference to inventive and comparative examples. Physical properties or the like were measured as mentioned below.

(1) Primary Dispersion Peak Temperature

A sample was let stand in an atmosphere of 23° C. and 50% RH (relative humidity) for 24 hours. Then, using a dynamic viscoelastometer RSA made by Rheometric Co., Ltd., a temperature dispersion curve for loss tangent tanδ was found by heating the sample from −100° C. to 120° C. at a heating rate of 2° C./min., an inter-chuck distance of 20 mm and a measuring frequency of 10 Hz. The primary dispersion peak temperature (° C.) is defined by a temperature at which that temperature dispersion curve shows a maximum.

(2) Crystallinity

A sample (about 10 mg) was set at a measuring cell in a differential scanning calorimeter DSC7 made by Parkin Elmer Co., Ltd. while it was heated from 30° C. to 200° C. at a heating temperature of 10° C./min. in a nitrogen atmosphere, thereby determining a DSC curve. The melting enthalpy ΔH(J/g) of a crystal was found from that DSC curve, and the crystallinity (% by weight) was calculated from the following expression:

Crystallinity=(ΔH/ΔH₀)×100

where ΔH₀=190.88 (J/g).

(3) Long Period Measured by Small Angle X-Ray Scattering

Fibers were aligned with one another in a uniform direction in a strip form of 20 mm in length and 4 mm in width, and fixed together by a cyanoacrylate bonding agent, thereby preparing a sample. X-rays were entered in the sample in a direction vertical to the drawing direction of the sample fibers. For an X-ray generator, Rotor Flex RU-200B made by Rigaku Denki Co., Ltd. was used, and CuKα rays passed through an Ni filter at 40 kV-200 mA was used as an X-ray source. Using an imaging plate (BAS-SR 127 made by Fuji Photo Film Co., Ltd.), the sample was exposed at a sample-imaging plate distance of 500 mm for an exposure time of 24 hours, and a meridian scattering angle strength profile curve was prepared using R-AXIS DS3 made by Rigaku Denki Co., Ltd. The long period (Å) was determined from a peak angle of this scattering angle strength profile curve.

(4) Degree of Orientation Measured by Wide-Angle X-Ray Scattering

Fibers were aligned with one another in a uniform direction in a strip form of 20 mm in length and 4 mm in width, and fixed together by a cyanoacrylate bonding agent, thereby preparing a sample. X-rays were entered in the sample in a direction vertical to the drawing direction of the sample fibers. For an X-ray generator, Rotor Flex RU-200B made by Rigaku Denki Co., Ltd. was used, and CuKα rays passed through an Ni filter at 30 kV-100 mA was used as an X-ray source. Using an imaging plate (BAS-SR 127 made by Fuji Photo Film Co., Ltd.), the sample was exposed at a sample-imaging plate distance of 60 mm for an exposure time of 20 minutes, and an azimuth angle (β angle) strength profile curve for diffraction from α type crystallographic (200) plane of polyamide 6 was prepared using R-AXIS DS3 made by Rigaku Denki Co., Ltd. According to “HOW TO MEASURE THE DEGREE OF ORIENTATION OF FIBER SAMPLES” set forth at page 81 of “GUIDE FOR X-RAY DIFFRACTION”, Revised 3rd Edition (published from Rigaku Denki Co., Ltd. on Jun. 30, 1985), the total sum ΣWi of half peak widths (degree) with respect to equatorial two points (β angles of 90° and 270°) was found to determine the degree of orientation (%) from the following expression:

Degree of Orientation=[(360−ΣWi)/360]×100

(5) Linear Tensile Strength

A sample was let stand in a temperature/humidity-controlled chamber of 23° C. and 50% RH for 24 hours. Then, using Tensilon UTM-3 made by Toyo Baldwin Co., Ltd in that chamber, tensile testing was carried out at an initial sample length (inter-chuck distance) of 300 mm and a crosshead speed of 300 mm/min. to find stress at rupture (MPa) by which the linear tensile strength (MPa) was defined.

(6) Biodegradability (Microbiological Biodegradability)

After buried in the ground for 6 months, a sample was dug out of the ground. When the sample fibers lost their shape or their linear tensile strength was at least 50% lower than that before burying, the biodegradability was evaluated as being satisfactory.

### Example 1

A polyesteramide copolymer (BAK1095 made by Bayer Co., Ltd.: nylone 6/polybutylene adipate=50/50 (mol %); a melting point (Tm) of 125° C. and a relative viscosity of 1.47) was fed to a 30-mmφ single-screw extruder, where the copolymer was molten at a leading end temperature of 140° C., and then extruded out of a spinning nozzle regulated to 140° C. and having a diameter of 1.5 mm, immediately whereupon the filament was cooled in a water bath regulated to 5° C. and then taken off at a take-off speed of 3 m/min, thereby obtaining an undrawn filament of 740 μm in diameter. While wound on a roll, the undrawn filament was let stand at room temperature (25° C.) for a day, after which the undrawn filament was found to have a crystallinity of 14.7% by weight. The filament having an enhanced crystallinity was drawn in a dry heat bath regulated to a temperature of 80° C. at a draw ratio of 5 times, thereby obtaining a drawn fiber (a monofilament having a diameter of 165 μm).

On the other hand, that filament was hot pressed at 140° C. for 5 minutes into a pressed sheet of 250 μm in thickness, thereby preparing a non-oriented sheet sample of the aforesaid polyesteramide copolymer. This non-oriented sheet sample was found to have a primary dispersion peak temperature of −11° C.

### Examples 2-3

Drawing filaments were obtained as Example 1 with the exception that the draw ratio for the undrawn filaments was changed from 5 times to 6 times (Example 2), and 7 times (Example 3).

### Example 4

A drawn filament was obtained as in Example 1 with the exception that the drawing step was divided into two stages, the first stage where drawing was carried out at 45° C. and a draw ratio of 4.5 times and the second stage where drawing was carried out at 75° C. and a draw ratio of 1.33 times in such a way as to give a total draw ratio of 6 times.

### Comparative Examples 1-3

Drawn filaments were obtained as in Example 1 with the exception that the draw ratio for the undrawn filaments was changed from 5 times to 2 times (Comparative Example 1), 3 times (Comparative Example 2), and 4 times (Comparative Example 3).

### Comparative Example 4

A polyesteramide copolymer (BAK1095 made by Bayer Co., Ltd.) was fed to a 30-mmφ single-screw extruder, where the copolymer was molten at a leading end temperature of 140° C., and then extruded out of a spinning nozzle regulated to 140° C. and having a diameter of 1.5 mm, immediately whereupon the filament was cooled in a water bath regulated to 5° C., and then taken off at a take-off speed of 10 m/min, thereby obtaining an undrawn filament of 740 μm in diameter. Immediately whereupon, i.e., without being taken up, the undrawn filament was drawn in a dry heat bath regulated to a temperature of 25° C. at a draw ratio of 3.5 times, thereby obtaining a drawn fiber (a monofilament having a diameter of 197 μm).

### Comparative Examples 5-6

Drawn fibers were obtained following Comparative Example 4 with the exception that the draw ratio for the undrawn filaments was changed from 3.5 times to 4.5 times (Comparative Example 5), and 5.5 times (Comparative Example 6).

### Comparative Example 7

A drawn filament was obtained following Comparative Example 4 with the exception that the drawing step was divided into three drawing stages, the first stage where drawing was carried out at 25° C. and a draw ratio of 4.5 times, the second stage where drawing was carried out at 25° C. and a draw ratio of 1.44 times and the third stage where drawing was carried out at 25° C. and a draw ratio of 1.15 times in such a way as to give a total draw ratio of 7.5 times.

### Example 5

The drawn filament obtained in Comparative Example 7 (a monofilament obtained at a total draw ratio of 7.5 times) was let stand at room temperature for a day, after which the drawn filament was found to have a crystallinity of 26.2% by weight. The drawn filament having an enhanced crystallinity was drawn at 80° C. and a draw ratio of 1.6 times corresponding to a total draw ratio of 12 times.

### Comparative Example 8

Nylon 6 (homopolymer) was fed to a 30-mmφ single-screw extruder, where the copolymer was molten at a leading end temperature of 260° C., then extruded out of a spinning nozzle regulated to 260° C. and having a diameter of 1.5 mm, immediately whereupon the filament was cooled in a water bath regulated to 5° C., and then taken off at a take-off speed of 10 m/min, thereby obtaining an undrawn filament of 740 μm in diameter. Immediately whereupon, i.e., without being taken up, the undrawn filament was drawn in a dry heat bath regulated to a temperature of 85° C. at a draw ratio of 3.8 times and then a dry heat bath regulated to a temperature of 95° C. and a draw ratio of 1.47 times, thereby obtaining a fiber (a monofilament having a diameter of 156 μm) drawn at a total draw ratio of 5.6 times.

The drawing conditions used in these inventive and comparative examples are shown in Table 1, and the physical property measurements are tabulated in Table 2.

TABLE 1

| | Pre-treatment | | | | | | |
|---|---|---|---|---|---|---|---|
| | conditions | | | Drawing conditions | | | |
| | Temperature | Time | Crystallinity | Temperature | | Total draw | |
| | (° C.) | (h) | (wt. %) | (° C.) | Draw Ratio | ratio | Remarks |
| Comp. | 25 | 24 | 14.7 | 80 | 2 | 2 | Crystalline drawing |
| Ex. 1 | | | | | | | |
| Comp. | 25 | 24 | 14.7 | 80 | 3 | 3 | Crystalline drawing |
| Ex. 2 | | | | | | | |
| Comp. | 25 | 24 | 14.7 | 80 | 4 | 4 | Crystalline drawing |
| Ex. 3 | | | | | | | |
| Ex. 1 | 25 | 24 | 14.7 | 80 | 5 | 5 | Crystalline drawing |
| Ex. 2 | 25 | 24 | 14.7 | 80 | 6 | 6 | Crystalline drawing |
| Ex. 3 | 25 | 24 | 14.7 | 80 | 7 | 7 | Crystalline drawing |
| Ex. 4 | 25 | 24 | 14.7 | 45/75 | 4.5/1.33 | 6 | Crystalline drawing |
| | | | | | | | (2-stage) |
| Ex. 5 | 25 | 24 | 26.2 | 80 | 1.6 | 12 | Amorphous drawing/ |
| | | | | | | | Crystalline drawing |

| | | | | | | |
|---|---|---|---|---|---|---|
| Comp. | None | — | 25 | 3.5 | 3.5 | Amorphous drawing |
| Ex. 4 | | | | | | |
| Comp. | None | — | 25 | 4.5 | 4.5 | Amorphous drawing |
| Ex. 5 | | | | | | |
| Comp. | None | — | 25 | 5.5 | 5.5 | Amorphous drawing |
| Ex. 6 | | | | | | |
| Comp. | None | — | 25 | 4.5/1.44/1.15 | 7.5 | Amorphous drawing |
| Ex. 7 | | | | | | (3-stage) |
| Comp. | None | — | 85/95 | 3.8/1.47 | 5.6 | Nylon 6 (2-stage) |
| Ex. 8 | | | | | | |

Note:
In Example 5, the drawn fibers obtained in Comparative Example 7 (having a total draw ratio of 7.5 times) were crystallized and then drawn.

TABLE 2

| | Structural parameters of drawn fibers | | | | | | | | |
|---|---|---|---|---|---|---|---|---|---|
| | | Primary dispersion peak | | | | | | | |
| | | temperature | | | | | | | |
| | | | Difference | | | | | Mechanical strength | |
| | Degree of | | with non- | Crystal- | Long | | | Linear | |
| | crystal | | oriented | linity | period | | | tensile | |
| | orientation | Temperature | material | A | B | A × B/ | Biodegrad- | strength | Elongation |
| | (%) | (° C.) | (° C.) | (wt. %) | (Å) | 100 | ability | (MPa) | (%) |
| Comp. | 85.9 | −10.1 | 0.9 | 17.3 | 80.2 | 13.9 | Satisfac- | 168.6 | 266 |
| Ex. 1 | | | | | | | tory | | |
| Comp. | 90.3 | −4.0 | 7.0 | 15.7 | 80.6 | 12.7 | Satisfac- | 251.9 | 120 |
| Ex. 2 | | | | | | | tory | | |
| Comp. | 92.9 | −1.8 | 9.2 | 21.2 | 82.9 | 17.6 | Satisfac- | 290.1 | 58 |
| Ex. 3 | | | | | | | tory | | |
| Ex. 1 | 93.4 | 0.1 | 11.1 | 22.2 | 84.1 | 18.7 | Satisfac- | 392.0 | 47 |
| | | | | | | | tory | | |
| Ex. 2 | 93.9 | 1.1 | 12.1 | 22.1 | 82.5 | 18.2 | Satisfac- | 475.3 | 27 |
| | | | | | | | tory | | |
| Ex. 3 | 94.1 | 2.0 | 13.0 | 23.3 | 82.9 | 19.3 | Satisfac- | 520.4 | 24 |
| | | | | | | | tory | | |
| Ex. 4 | 94.4 | 3.0 | 14.0 | 20.1 | 83.3 | 16.7 | Satisfac- | 502.7 | 21 |
| | | | | | | | tory | | |
| Ex. 5 | 95.0 | 3.0 | 14.0 | 22.1 | 83.0 | 18.3 | Satisfac- | 614.5 | 19 |
| | | | | | | | tory | | |
| Comp. | 88.8 | −9.8 | 1.2 | 27.9 | 74.5 | 20.8 | Satisfac- | 145.0 | 163 |
| Ex. 4 | | | | | | | tory | | |
| Comp. | 91.3 | −9.8 | 1.2 | 13.7 | 73.9 | 10.1 | Satisfac- | 199.9 | 81 |
| Ex. 5 | | | | | | | tory | | |
| Comp. | 91.5 | −9.7 | 1.3 | 23.0 | 73.3 | 16.9 | Satisfac- | 253.8 | 66 |
| Ex. 6 | | | | | | | tory | | |
| Comp. | 93.9 | −8.7 | 2.3 | 26.2 | 79.9 | 20.9 | Satisfac- | 369.5 | 49 |
| Ex. 7 | | | | | | | tory | | |
| Comp. | 94.3 | — | — | 34.0 | 103.0 | 35.0 | Poor | — | — |
| Ex. 8 | | | | | | | | | |

### INDUSTRIAL APPLICABILITY

The present invention provides a high-strength polyesteramide fiber that has high linear tensile strength and reasonable elongation and shows biodegradability as well as a process for the production of the same. The high-strength polyesteramide fibers of the invention find preferable applications for industrial materials such as fishing lines, fishing nets and agricultural nets.

1. A high-strength polyesteramide fiber comprising a polyesteramide copolymer, which has a primary dispersion peak temperature of at least 10° C. higher than a primary dispersion peak temperature of a non-oriented material comprising the polyesteramide copolymer, as measured by dynamic viscoelastometry.

2. The high-strength polyesteramide fiber according to claim 1, wherein a relation between a crystallinity A (% by weight) of the fiber and a long period B (Å) of the fiber as measured by small angle X-ray scattering satisfies the following formula (I):
5≦(A×B)/100≦30 (I).

3. The high-strength polyesteramide fiber according to claim 1, wherein the polyesteramide copolymer comprises 5 to 80 mol % of a polyamide unit and 20 to 95 mol % of a polyester unit.

4. The high-strength polyesteramide fiber according to claim 1, wherein the polyesteramide copolymer is a polyesteramide copolymer having a melting point of 90 to 180° C.

5. The high-strength polyesteramide fiber according to claim 1, wherein the polyesteramide copolymer is a polyesteramide copolymer having a relative viscosity of 1.0 to 3.0.

6. The high-strength polyesteramide fiber according to claim 1, wherein the polyesteramide copolymer is a nylon 6/polybutylene adipate copolymer, a nylon 66/polybutylene adipate copolymer, a nylon 6/polyethylene adipate copolymer, a nylon 66/polyethylene adipate copolymer, a nylon 6/polycaprolactone copolymer or a nylon 66/polycaprolactone copolymer.

7. The high-strength polyesteramide fiber according to claim 1, wherein the fiber comprising the polyesteramide copolymer has a primary dispersion peak temperature of 10 to 17° C. higher than a primary dispersion peak temperature of a non-oriented material comprising the polyesteramide copolymer, as measured by dynamic viscoelastometry.

8. The high-strength polyesteramide fiber according to claim 1, which has a linear tensile strength of 380 to 700 MPa.

9. The high-strength polyesteramide fiber according to claim 1, which has an elongation of 10 to 50%.

10. The high-strength polyesteramide fiber according to claim 1, which is a drawn filament obtained by drawing an amorphous undrawn filament comprising a polyesteramide copolymer after a crystallinity thereof has been enhanced to 10 to 30% by weight.

11. The high-strength polyesteramide fiber according to claim 1, which is obtained by drawing an amorphous undrawn filament comprising a polyesteramide copolymer, and then enhancing a crystallinity of the obtained drawn filament to 10 to 30% by weight, followed by a further drawing.

12. The high-strength polyesteramide fiber according to claim 1, which is biodegradable.

13. A polyesteramide fiber production process comprising melt spinning a polyesteramide copolymer and drawing the resultant undrawn filament, which comprises a series of steps of:
(1) melt spinning the polyesteramide copolymer, immediately followed by solidification by cooling in an inert cooling medium having a temperature of 20° C. or lower, thereby obtaining an undrawn filament,
(2) enhancing a crystallinity of the undrawn filament to 10 to 30% by weight, and
(3) subjecting the undrawn filament having a crystallinity of 10 to 30% by weight to a single- or multi-stage drawing in such a way as to give a total draw ratio of 4.5 times or greater.

14. The production process according to claim 13, wherein at step (2) the undrawn filament is placed in an atmosphere of 10 to 80° C. for 10 minutes to 72 hours, thereby enhancing the crystallinity of the undrawn filament to 10 to 30% by weight.

15. The production process according to claim 13, wherein at step (3) the undrawn filament having a crystallinity of 10 to 30% by weight is subjected to the single- or multi-stage drawing at a temperature of 20 to 120° C. in such a way as to give a total draw ratio of 4.5 times or greater, wherein there is at least one drawing stage for carrying out drawing at a temperature of 50 to 120° C. at a draw ratio of 1.3 times or greater.

16. A polyesteramide fiber production process comprising melt spinning a polyesteramide copolymer and drawing the resultant undrawn filament, which comprises a series of steps of:
(I) melt spinning the polyesteramide copolymer, immediately followed by solidification by cooling in an inert cooling medium having a temperature of 20° C. or lower, thereby obtaining an undrawn filament,
(II) drawing the undrawn filament at a temperature of −10° C. to 50° C. and at a draw ratio of 1.3 times or greater, thereby obtaining a drawn filament,
(III) enhancing a crystallinity of the drawn filament to 10 to 30% by weight, and
(IV) subjecting the drawn filament having a crystallinity of 10 to 30% by weight to a single- or multi-stage drawing in such a way as to give a total draw ratio of 4.5 times or greater.

17. The production process according to claim 16, wherein at step (II) the undrawn filament is drawn at a temperature of 20° C. to lower than 50° C. and at a draw ratio of 1.3 to 10 times.

18. The production process according to claim 16, wherein at step (III) the drawn filament is placed in an atmosphere of 10 to 80° C. for 10 minutes to 72 hours, thereby enhancing the crystallinity of the drawn filament to 10 to 30% by weight.

19. The production process according to claim 16, wherein at step (IV) the drawn filament having a crystallinity of 10 to 30% by weight is subjected to the single- or multi-stage drawing at a temperature of 20 to 120° C. in such a way as to give a total draw ratio of 4.5 times or greater, wherein there is at least one drawing stage for carrying out drawing at a temperature of 50 to 120° C. at a draw ratio of 1.3 times or greater.
